(19) United States
(12) Patent Application Publication
(10) Pub. No.: US 2017/0275166 A1
(43) Pub. Date: Sep. 28, 2017

(54) METHOD FOR PRODUCING METAL OXIDES BY MEANS OF SPRAY PYROLYSIS

(71) Applicants: Stipan KATUSIC, Bad Soden (DE); Peter KRESS, Karlstein (DE); Harald ALFF, Kahl (DE); Armin WIEGAND, Grosskrotzenburg (DE)

(72) Inventors: Stipan KATUSIC, Bad Soden (DE); Peter KRESS, Karlstein (DE); Harald ALFF, Kahl (DE); Armin WIEGAND, Grosskrotzenburg (DE)

(73) Assignee: Evonik Degussa GmbH, Essen (DE)

(21) Appl. No.: 15/529,326

(22) PCT Filed: Nov. 12, 2015
(86) PCT No.: PCT/EP2015/076405

§ 371 Date: May 24, 2017

(30) Foreign Application Priority Data
Nov. 25, 2014 (EP) 14194632.7

(51) Int. Cl. C01B 13/34; C01G 51/04; C01F 17/00; C01G 25/02; C01F 7/30; C01G 45/02; C01G 53/04

(52) U.S. Cl. CPC C01B 13/34; C01G 45/02; C01G 51/04; C01G 53/04; C01G 25/02; C01F 7/308; C01F 17/0043

(57) ABSTRACT

A process for producing a metal oxide powder proceeds by spray pyrolysis, in which a mixture comprising ammonia and an aerosol which is obtained by atomizing a solution containing a metal compound by means of an atomization gas is introduced into a high-temperature zone of a reaction space and reacted in an oxygen-containing atmosphere therein and the solids are subsequently separated off.

The invention relates to a process for producing metal oxides by means of spray pyrolysis.

Spray pyrolysis and flame spray pyrolysis are established processes for producing metal oxides. In a spray pyrolysis, metal compounds in the form of fine droplets are introduced into a high-temperature zone where they are oxidized and/or hydrolysed to give metal oxides. A special form of this process is that of flame spray pyrolysis, in which the droplets are supplied to a flame which is formed by ignition of a combustion gas and an oxygen-containing gas.

Numerous reaction parameters are available to the person skilled in the art in order to vary the physicochemical properties of the metal oxides produced. For instance, the temperature, concentration of the metal compound, residence time and flow rate of the reaction mixture influence the structure of the metal oxides.

Particularly on conversion to an industrial scale, it is found that unwanted products are formed, for example in the form of hollow beads, or that the size distribution of the metal oxide particles is extremely broad. There is therefore a search for processes which minimize these disadvantages.

The present invention provides a process for producing a metal oxide powder by means of spray pyrolysis, in which a mixture comprising ammonia and an aerosol which is obtained by atomizing a solution containing a metal compound by means of an atomization gas, preferably nitrogen or air, is introduced into a high-temperature zone of a reaction space and reacted in an oxygen-containing atmosphere therein and the solids are subsequently separated off.

The processes according to the invention may exclude a process for producing metal oxide powders of the composition LiₓLa₃Zr₂M_{y}O_{8.5+0.5x+z} with 6.5≦x≦8, 0≦y≦0.5, z=2y for M=Hf, Ga, Ge, Nb, Si, Sn, Sr, Ta, Ti; z=1.5y for M=Sc, V, Y; z=y for M=Ba, Ca, Mg, Zn, by means of spray pyrolysis, in which a mixture comprising ammonia and an aerosol, where the aerosol contains a metal compound and an atomization gas, is introduced into a high-temperature zone of a reaction space and reacted in an oxygen-containing atmosphere therein and the solids are subsequently separated off.

The processes according to the invention may likewise exclude a process for preparing a metal oxide powder of the composition LiₓLa₃Zr₂M_{y}O_{8.5+0.5x+1.5 y} with 6≦x≦7, 0.2≦y≦0.5, in which a solution or a plurality of solutions each containing one or more compounds of lithium, lanthanum, aluminium and zirconium, in a concentration corresponding to the stoichiometry and in the form of fine droplets, are introduced into a flame burning within a reaction space, which is formed by introducing an oxygen-containing gas and a combustion gas which forms water when reacted with oxygen is introduced into the reaction space and ignited therein, and the solids are subsequently separated from vaporous or gaseous substances.

The concentration of ammonia is preferably 0.5-5.0 kg NH₃/kg of the metals used, more preferably 1.5-3.5 kg/kg. Within these ranges, the influence on the homogeneity of the metal oxide particles to be produced is at its greatest.

In a preferred embodiment, the high-temperature zone into which the mixture is introduced is a flame which is formed by the reaction of an oxygen-containing gas and a combustion gas, preferably combustion gas which forms water in the reaction with oxygen.

The combustion gas used may be hydrogen, methane, ethane, propane, butane and mixtures thereof. Preference is given to using hydrogen.

The oxygen-containing gas is generally air. In the process according to the invention, the amount of oxygen should be chosen so as to be sufficient at least for complete conversion of the combustion gas and of all the metal compounds. It is generally advantageous to use an excess of oxygen. This excess is appropriately expressed as the ratio of oxygen present/oxygen required for combustion of the combustion gas and is identified as lambda. Lambda is preferably 1.5 to 6.0, more preferably 2.0 to 4.0.

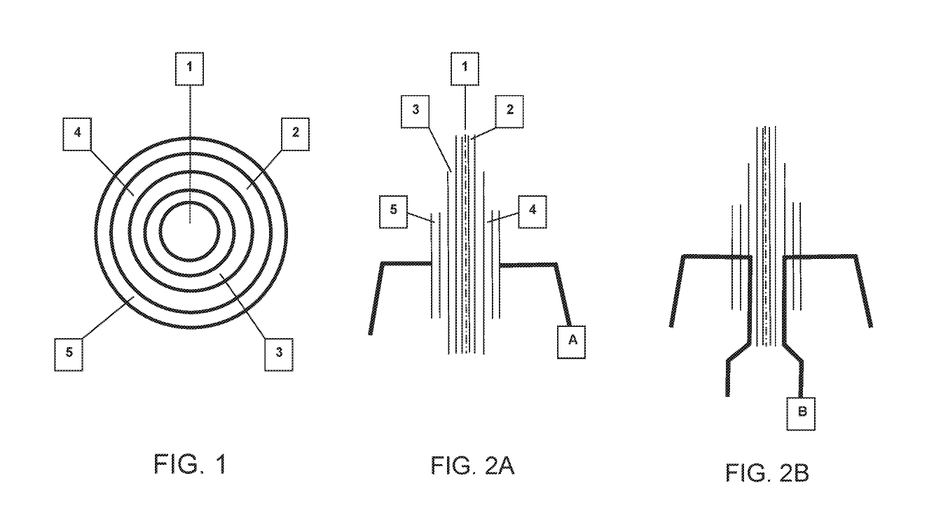

FIGS. 1, 2A and 2B show schematics of a possible arrangement for introduction of the feedstocks into the reaction space, where: 1=solution containing metal compound, 2=atomization gas, 3=ammonia, 4=air, 5=combustion gas, A=reaction chamber wall.

In a particular embodiment, the flame and the mixture are at least partly spatially separated from one another within the reaction space. FIG. 2B shows a schematic of such an arrangement, in which a bell jar B surrounds the mixture introduced into the reaction space. The metal oxide particles thus produced have particularly high homogeneity in terms of the particle size distribution.

The positive effect in terms of homogeneity can be enhanced further when, in this embodiment, the mean velocity of the flame, v_{flame} is greater than the mean velocity of the mixture vₘᵢₓₜᵤᵣₑ. More preferably, 2≦v_{flame}/vₘᵢₓₜᵤᵣₑ≦10; most preferably, 3≦v_{flame}/vₘᵢₓₜᵤᵣₑ≦5. The velocity figures are normalized velocities. They are found by dividing the volume flow rate having the unit m³ (STP)/h by the cross-sectional area.

In the process according to the invention, the solution(s) are introduced into the reaction space in the form of fine droplets. Preferably, the fine droplets have a median droplet size of 1-120 μm, more preferably of 30-100 μm. The droplets are typically produced using single or multiple nozzles.

In order to achieve solubility and in order to attain a suitable viscosity for the atomization of the solution, the solution can be heated. In principle, it is possible to use all soluble metal compounds which are oxidizable.

The metal component of the metal compound is preferably selected from the group consisting of Ag, Al, B, Ba, Ca, Cd, Co, Cr, Cu, Fe, Ga, Ge, Hf, In, Li, Mg, Mn, Mo, Nb, Ni, Pd, Rh, Ru, Sc, Si, Sn, Sr, Ta, Ti, V, Y and Zn. In principle, it is also possible to use a plurality of metal components, such that mixed oxides are obtained.

These may be inorganic metal compounds, such as nitrates, chlorides, bromides, or organic metal compounds, such as alkoxides or carboxylates. The alkoxides used may preferably be ethoxides, n-propoxides, isopropoxides, n-butoxides and/or tert-butoxides. The carboxylates used may be the compounds based on acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid and/or lauric acid. From the group of the organic metal compounds, preference is given to using 2-ethylhexanoates or laurates. The solution may comprise one or more inorganic metal compounds, one or more organic metal compounds or mixtures of inorganic and organic metal compounds.

In a preferred embodiment, at least one metal compound is a nitrate. The metal oxide particles thus produced have particularly high homogeneity in terms of the particle size distribution.

The solvents can preferably be selected from the group consisting of water, C₅-C₂₀-alkanes, C₁-C₁₅-alkanecarboxylic acids and/or C₁-C₁₅-alkanols. Organic solvents used, or constituents of organic solvent mixtures used, may preferably be alcohols such as methanol, ethanol, n-propanol, isopropanol, n-butanol or tert-butanol, diols such as ethanediol, pentanediol, 2-methylpentane-2,4-diol, C₁-C₁₂-carboxylic acids such as acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid, lauric acid. It is additionally possible to use benzene, toluene, naphtha and/or benzine.

Preference is given to using aqueous solutions, an aqueous solution being understood to mean a solution in which water is the main constituent of a solvent mixture or in which water alone is the solvent.

The concentration of the solutions used is not particularly limited. If only one solution containing all the mixed oxide components is present, the concentration is generally 1% to 50% by weight, preferably 3% to 30% by weight, most preferably 5%-20% by weight, based in each case on the sum total of the oxides.

### EXAMPLES

The BET surface area is determined to DIN ISO 9277. The d₅₀ results from the cumulative distribution curve of the volume-average size distribution. This is typically determined by laser diffraction. In the context of the present invention, a Cilas 1064 instrument from Cilas is used for this purpose. A d₅₀ is the value at which 50% of the particles are within the size range indicated.

Metal compounds used are the respective nitrates. Examples without ammonia (suffix 0; comparative examples) and with ammonia (suffix 1; inventive examples) are conducted in each case.

### Example Mn₀

2 kg/h of a solution of manganese nitrate having a manganese concentration of 15.3% by weight are atomized with 5 m³ (STP)/h of air as atomization gas by means of a two-phase nozzle into a flame burning within a reaction space. The flame is formed by the reaction of 10 m³ (STP)/h of hydrogen and 30 m³ (STP)/h of air. After cooling, the metal oxide powder is separated from gaseous substances at a filter.

The examples Co₀, Ni₀, Zr₀, La₀, Al₀ and Ce₀ are conducted analogously. Amounts of feedstocks are shown in the table.

### Example Mn₁

Like Mn₀, except that a further 0.6 kg/h of ammonia are atomized into the reaction space as well as the solution and the atomizer air.

The examples Co₁, Ni₁, Zr₁, La₁, Al₁ and Ce₁ are conducted analogously. Amounts of feedstocks are shown in the table.

The metal oxide powders produced by the process according to the invention have lower values for BET surface area and mean particle size distribution.

TABLE
Feedstocks and reaction conditions; physical properties

| | | Example | | | | | | | | | | | | | |
|---|---|---|---|---|---|---|---|---|---|---|---|---|---|---|---|
| | | Mn₀ | Mn₁ | Co₀ | Co₁ | Ni₀ | Ni₁ | Zr₀ | Zr₁ | La₀ | La₁ | Al₀ | Al₁ | Ce₀ | Ce₁ |
| Solution | kg/h | 2 | 2 | 2 | 2 | 2 | 2 | 4 | 4 | 3 | 3 | 4 | 4 | 4 | 4 |
| Conc. of Metal | % by wt. | 15.3 | 15.3 | 14.6 | 14.6 | 14.4 | 14.4 | 6.5 | 6.5 | 9.6 | 9.6 | 4.0 | 4.0 | 6.0 | 6.0 |
| Atomizer air | m³ | 5 | 5 | 5 | 5 | 5 | 5 | 5 | 5 | 5 | 5 | 5 | 5 | 5 | 5 |
| | (STP)/h | | | | | | | | | | | | | | |
| Ammonia | kg/h | 0 | 0.6 | 0 | 0.6 | 0 | 0.6 | 0 | 0.6 | 0 | 0.6 | 0 | 0.6 | 0 | 0.6 |
| Ammonia/metal | kg/kg | 0 | 1.96 | 0 | 2.05 | 0 | 2.08 | 0 | 2.31 | 0 | 2.08 | 0 | 3.75 | 0 | 2.50 |
| Hydrogen | m³ | 10 | 12 | 10 | 12 | 10 | 12 | 12 | 12 | 12 | 12 | 12 | 12 | 12 | 12 |
| | (STP)/h | | | | | | | | | | | | | | |
| Primary air | m³ | 30 | 30 | 30 | 30 | 30 | 30 | 30 | 30 | 30 | 30 | 30 | 30 | 30 | 30 |
| | (STP)/h | | | | | | | | | | | | | | |
| Lambda | | 1.68 | 1.40 | 1.68 | 1.40 | 1.68 | 1.40 | 1.40 | 1.40 | 1.40 | 1.40 | 1.40 | 1.40 | 1.40 | 1.40 |
| Vₘᵢₓₜᵤᵣₑ | Nm/s | 0.33 | 0.40 | 0.32 | 0.39 | 0.32 | 0.39 | 0.41 | 0.46 | 0.39 | 0.43 | 0.44 | 0.48 | 0.44 | 0.48 |
| V_{flame} | Nm/s | 1.42 | 1.64 | 1.39 | 1.60 | 1.36 | 1.59 | 1.52 | 1.56 | 1.53 | 1.63 | 1.59 | 1.65 | 1.58 | 1.64 |
| V_{flame}/Vₘᵢₓₜᵤᵣₑ | | 4.3 | 4.1 | 4.3 | 4.1 | 4.3 | 4.1 | 3.7 | 3.4 | 3.9 | 3.8 | 3.6 | 3.4 | 3.6 | 3.4 |
| T_{flame}^{a)} | ° C. | 646 | 742 | 623 | 712 | 611 | 708 | 636 | 659 | 663 | 700 | 683 | 708 | 674 | 700 |
| BET surface | m²/g | 4.3 | 3.2 | 4.3 | 3.7 | 13.0 | 9.3 | 7.0 | 6.0 | 8.2 | 7.3 | 12.0 | 12.0 | 5.7 | 5.2 |
| area | | | | | | | | | | | | | | | |
| d₁₀ | μm | 0.10 | 0.09 | 0.24 | 0.09 | 0.21 | 0.07 | 0.41 | 0.36 | 0.36 | 0.31 | 0.78 | 0.75 | 0.20 | 0.16 |
| d₅₀ | μm | 0.25 | 0.21 | 0.38 | 0.18 | 0.59 | 0.42 | 3.53 | 3.01 | 2.29 | 1.68 | 6.80 | 5.64 | 1.22 | 0.95 |
| d₉₀ | μm | 0.10 | 0.09 | 0.24 | 0.09 | 0.21 | 0.07 | 0.41 | 0.36 | 0.36 | 0.31 | 0.78 | 0.75 | 0.20 | 0.16 |

^{a)}flame temperature; measured 10 cm below the feed point of air and hydrogen into the reaction space

1. A process for producing a metal oxide powder by spray pyrolysis, said process comprising:
introducing a mixture comprising ammonia and an aerosol which is obtained by atomizing a solution containing a metal compound by an atomization gas
into a high-temperature zone of a reaction space,
reacting said mixture in an oxygen-containing atmosphere in said reaction space, and
subsequently separating the solids off.

2. The process according to claim 1, wherein
the concentration of ammonia is 0.5-5.0 kg NH₃/kg of the metal used.

3. The process according to claim 1, wherein the high-temperature zone into which the mixture is introduced is a flame which is formed by the reaction of an oxygen-containing gas and a combustion gas.

4. The process according to claim 3, wherein
the flame and the mixture are at least partly spatially separated from one another within the reaction space.

5. The process according to claim 4, wherein
the following applies to the ratio of mean velocity of the flame to mean velocity of the mixture: 2≦v_{flame}/vₘᵢₓₜᵤᵣₑ≦10.

6. The process according to claim 1, wherein at least one metal compound is a nitrate.

7. The process according to claim 1, wherein
the metal component of the metal compounds is selected from the group consisting of Ag, Al, B, Ba, Ca, Cd, Co, Cr, Cu, Fe, Ga, Ge, Hf, In, Li, Mg, Mn, Mo, Nb, Ni, Pd, Rh, Ru, Sc, Si, Sn, Sr, Ta, Ti, V, Y and Zn.
